(19) United States
(12) Patent Application Publication
(10) Pub. No.: US 2009/0009728 A1
(43) Pub. Date: Jan. 8, 2009

(54) Projector with an external air filtration device

(75) Inventors: I-Hsien Liu, Hsinchu (TW); Tzu-Tse Huang, Hsinchu (TW); Chung-Hsien Yen, Hsinchu (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Coretonic Corporation, Hsinchu (TW)

(21) Appl. No.: 12/079,523

(22) Filed: Mar. 26, 2008

(30) Foreign Application Priority Data
Jul. 5, 2007 (TW) 096124431

(51) Int. Cl. G03B 21/16

(52) U.S. Cl. 353/57

(57) ABSTRACT

A projector includes a housing, an internal projection mechanism, and an external air filtration device. The housing has a ventilation window portion. The internal projection mechanism is disposed in the housing, and includes an imaging system, a light source system for providing a light beam to the imaging system, and a ventilating fan. The external air filtration device includes a frame, a filter member, and an engaging unit. The engaging unit engages removably the frame to the ventilation window portion of the housing for securing the filter member on the exterior of the housing between the frame and the ventilation window portion.

### CROSS-REFERENCES TO RELATED APPLICATIONS

This application claims priority to Taiwanese Application No. 096124431, filed Jul. 5, 2007, the disclosure of which is herein incorporated by reference.

### BACKGROUND OF THE INVENTION

1. Field of the Invention

The invention relates to a projector, more particularly to a projector provided with an external air filtration device.

2. Description of the Related Art

Normally, a projector utilizes a heat-dissipating fan to generate airflow that brings cold air into the projector and hot air out of the projector. Since a liquid crystal plate in the projector generates static electricity, dust carried by the air into the projector are attracted thereto and accumulate thereon, thereby adversely affecting the quality of projected images. Moreover, as the projector works in a dusted-environment, dust accumulates on a ventilation window of the projector over time, such that heat cannot be dissipated properly, thereby significantly decreasing lifetime of the projector.

As shown in FIG. 1, U.S. Patent Application Publication No. 2005254021 discloses a conventional projector provided with an air filtration device that is coupled slidably with a housing thereof and that includes a holder 10 and a filter 14. The holder 10 includes a first frame 12 coupled slidably with a sliding track 11 of the housing, and a second frame 13 pivoted to the first frame 12. In use, the filter 14 is clamped between the first frame 12 and the second frame 13 of the holder 10, and is held in position relative to the sliding track 11 by the holder 10, thereby achieving the air-filtering effect. When it is desired to replace or clean the filter 14, the holder 10 is first slid along the sliding track 11 to be out of the housing, and the second frame 13 is then pivoted away from the first frame 12 to permit removal of the filter 14.

Although the conventional projector can facilitate a user to replace and clean the filter 14, the housing has to be manufactured to correspond in structure to the air filtration device (i.e., by including the sliding track 11), and the sliding track 11 has to be assembled in the holder 10, thereby increasing the manufacturing cost of the conventional projector.

### SUMMARY OF THE INVENTION

An object of an embodiment of the present invention is to provide a projector with an external air filtration device. The external air filtration device is mounted removably to the projector, and not only provides an air-filtering effect, but is also easy to be cleaned or replaced. In addition, a housing of the projector does not need to be specially structured for use with the external air filtration device.

Therefore, according to an embodiment of the present invention, there is provided a projector that includes a housing, an internal projection mechanism, and an external air filtration device. The housing has a ventilation window portion. The internal projection mechanism is disposed in the housing, and includes an imaging system, a light source system for providing a light beam to the imaging system, and a ventilating fan. The external air filtration device includes a frame, a filter member, and an engaging unit. The engaging unit engages removably the frame to the ventilation window portion of the housing for securing the filter member on the exterior of the housing between the frame and the ventilation window portion to block the entry of dust into the housing via the ventilation window portion.

Preferably, the ventilation window portion includes a plurality of spaced apart bars, and the engaging unit is engaged to at least one of the bars.

In an embodiment of the present invention, the ventilation window portion serves as an airflow inlet for the ventilation fan.

In an embodiment of the present invention, the engaging unit includes a hook, a movable coupler, a sleeve portion and a pin, or a combination thereof. Preferably, the engaging unit includes at least one hook that extends from the frame toward the housing and that has a hooking end for hooking onto the ventilation window portion.

Preferably, the movable coupler is mounted movably on the frame and includes first and second segments. The first segment extends toward the ventilation window portion and has an engaging end for hooking onto the ventilation window portion, and the second segment extends from the first segment and is operable to engage removably the engaging end of the first segment to the ventilation window portion.

Preferably, the sleeve portion includes a plurality of resilient plate segments that extend from the inner side of the frame toward the housing, that cooperate to define a pin space with an open end at an outer side of the frame, and that are removably extendable between a pair of adjacent ones of the bars of the ventilation window portion. The pin extends removably into the pin space via the open end for urging the resilient plate segments of the sleeve portion to abut against the pair of the adjacent ones of the bars.

In an embodiment of the present invention, the projector further includes a fan speed control member disposed on the housing. The fan speed control member is operatively associated with the ventilation fan for controlling rotation speed of the ventilation fan.

In an embodiment of the present invention, the frame of the external air filtration device includes an operating member that extends into the housing and that is registered with the fan speed control member when the frame engages the ventilation window portion. The fan speed control member is actuated by the operating member to control the rotation speed of the ventilation fan.

By virtue of the engaging unit, the external air filtration device may be engaged directly to the housing of the projector. The advantages of simplicity in structure, unnecessary to modify an original structure of the housing, etc., help to reduce the manufacturing cost of the projector and facilitate convenient removal of the external air filtration device for cleaning by a user.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary exploded perspective view of a conventional projector disclosed in U.S. Patent Application Publication No. 2005254021;

FIG. 2 is a partly exploded perspective view of a first preferred embodiment of a projector according to the present invention;

FIG. 3 is a fragmentary sectional view, illustrating mounting of a first external air filtration device to a first ventilation window portion according to the first preferred embodiment;

FIG. 4 is a fragmentary sectional view, illustrating relative positions of a second external air filtration device and a second ventilation window portion according to the first preferred embodiment;

FIG. 5 is a fragmentary sectional view, illustrating mounting of the second external air filtration device to the second ventilation window portion according to the first preferred embodiment;

FIG. 6 is an enlarged sectional view, illustrating extension of a pin of an engaging unit of the second external air filtration device into a sleeve portion according to the first preferred embodiment;

FIG. 7 is an assembled perspective view of the first preferred embodiment;

FIG. 8 is a fragmentary schematic view of the engaging unit of the first external air filtration device according to a second preferred embodiment of the present invention;

FIG. 9 is a block diagram of a control mechanism of the projector;

FIG. 10 is a schematic diagram of the projector, illustrating an internal projection mechanism; and

FIG. 11 is a perspective view of a third preferred embodiment of a projector according to the present invention.

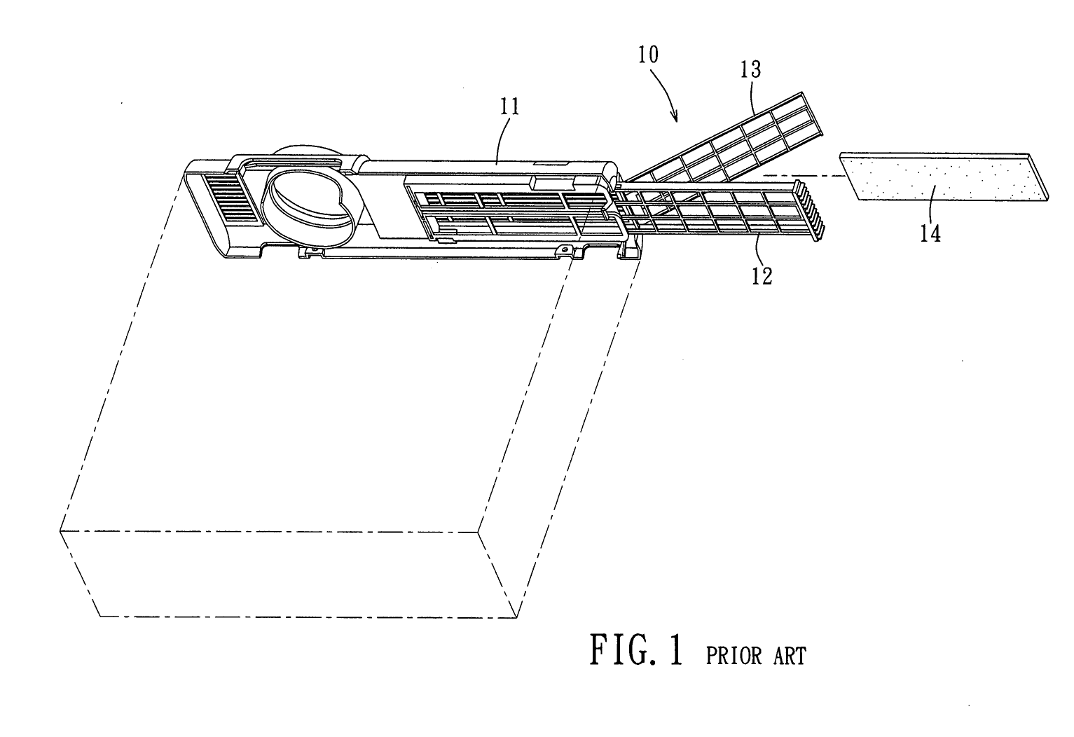

### DETAILED DESCRIPTION OF THE PREFERRED EMBODIMENTS

In the following detailed description of the preferred embodiments, reference is made to the accompanying drawings which form a part hereof, and in which there are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component faces “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

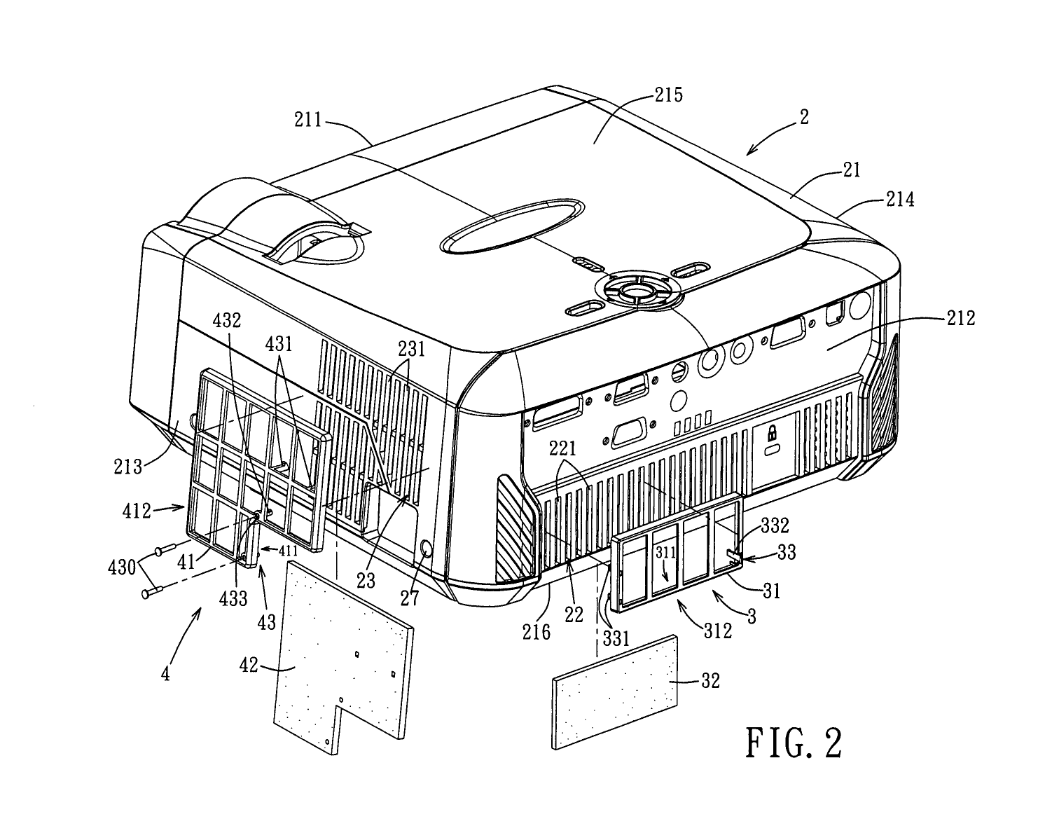

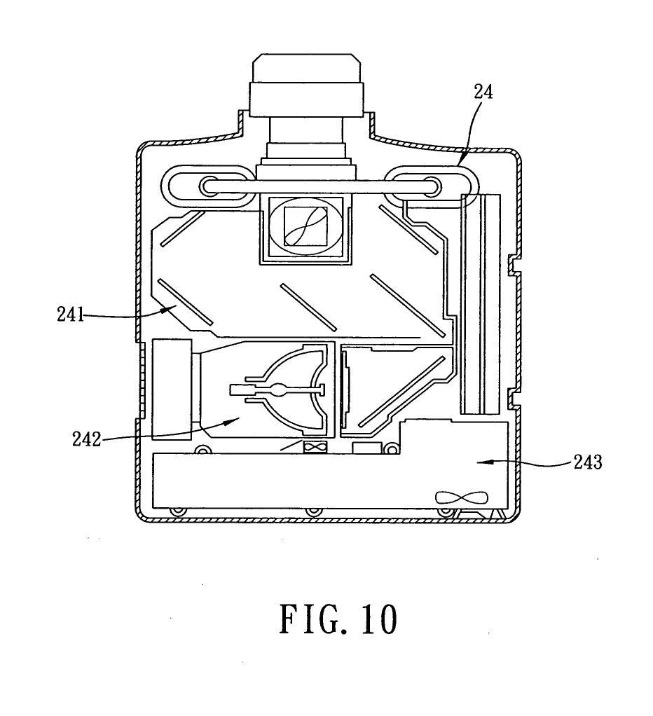

As shown in FIG. 2 and FIG. 10, a projector 2 according to a first preferred embodiment of the present invention includes a housing 21, an internal projection mechanism 24, a first external air filtration device 3, a second external air filtration device 4, and a fan speed control member 5. The housing 21 has a first ventilation window portion 22 and a second ventilation window portion 23. The internal projection mechanism 24 shown in FIG. 10 is disposed in the housing 21, and includes an imaging system 241, a light source system 242 for providing a light beam to the imaging system 241, and a ventilating fan 243 for dissipating heat generated in the projector 2.

In this embodiment, the housing 21 includes a front plate portion 211, a rear plate portion 212, two side plate portions 213, 214, a top plate portion 215, and a bottom plate portion 216. The plate portions 211˜216 cooperate to form a box shape.

Each of the first and second ventilation window portions 22, 23 includes a plurality of spaced apart bars 221, 231. In this embodiment, the first and second ventilation window portions 22, 23 are respectively provided on the rear plate portion 212 and the side plate portion 213. Each of the first and second ventilation window portions 22, 23 serves as an airflow inlet for the ventilation fan 243.

The first and second external air filtration devices 3, 4 are respectively disposed at an exterior of the first and second ventilation window portions 22, 23.

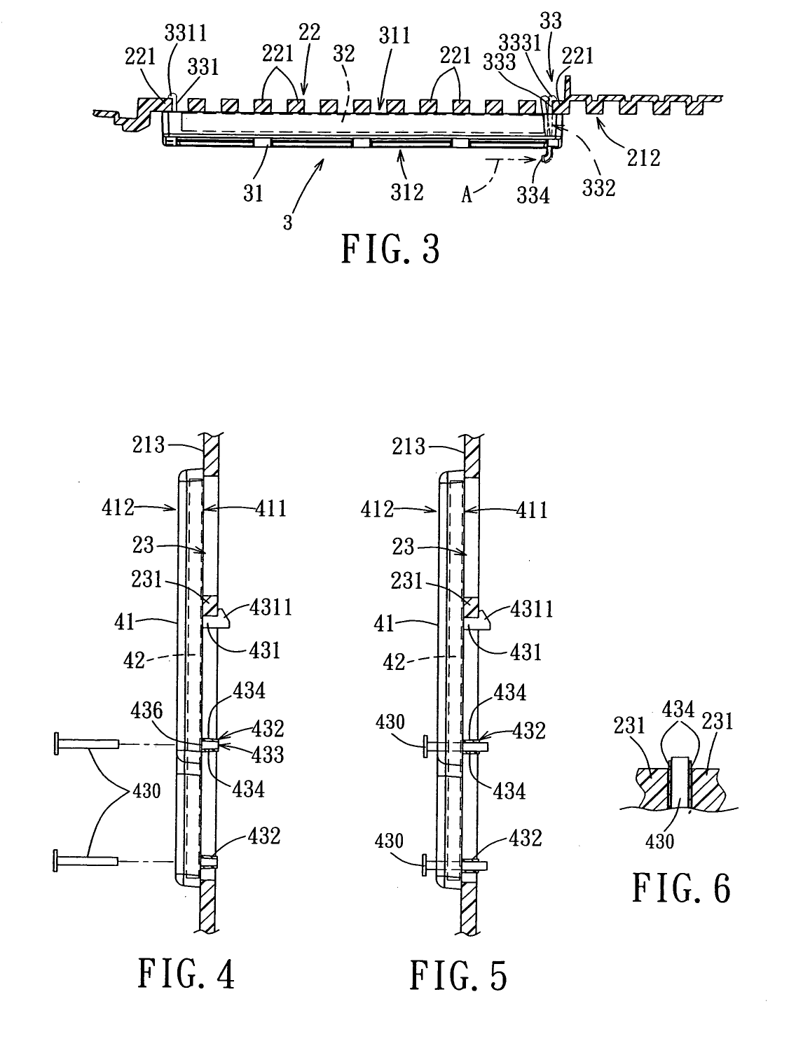

With further reference to FIG. 3, the first external air filtration device 3 includes a frame 31, a filter member 32 and an engaging unit 33 disposed on the frame 31. The frame 31 includes interconnected parallel and transverse bars, but should not be limited thereto in other embodiments of the present invention. The frame 31 has an inner side 311 facing the first ventilation window portion 22, and an outer side 312 opposite to the inner side 311.

In this embodiment, the engaging unit 33 includes two hooks 331 that are disposed at a left side of the frame 31, and that are vertically spaced apart from each other. In addition, the hooks 331 and the frame 31 are integrally formed, and the hooks 331 are plate-shaped. Moreover, the engaging unit 33 further includes a movable coupler 332 mounted movably on the right side of the frame 31. The movable coupler 332 includes a first segment 333 that extends toward the first ventilation window portion 22 and that has a hook-shaped engaging end 3331, and a second segment 334 that extends from the first segment 333 away from the first ventilation window portion 22 and that is operable to engage removably the engaging end 3331 of the first segment 333 to the first ventilation window portion 22.

As shown in FIG. 2 and FIG. 4, the second external air filtration device 4 includes a frame 41, a filter member 42 and an engaging unit 43 disposed on the frame 41. As with the first external air filtration device 3, the frame 41 of the second external air filtration device 4 includes a plurality of interconnected parallel and transverse bars, but should not be limited thereto in other embodiments of the present invention. The frame 41 has an inner side 411 facing the second ventilation window portion 23 of the housing 21, and an outer side 412 opposite to the inner side 411. The engaging unit 43 includes two hooks 431 that are horizontally spaced apart from each other, two sleeve portions 432, and two pins 430. Each of the hooks 431 extends from the frame 41 toward the housing 21, and has a hook-shaped engaging end 4311 for hooking onto the second ventilation window portion 23.

Each sleeve portion 432 includes a plurality of resilient plate segments 434 that extend from the inner side 411 of the frame 41 toward the housing 21, that cooperate to define a pin space 433 with an open end 436 at the outer side 412 of the frame 41, and that are removably extendable between an adjacent pair of the bars 231 of the second ventilation window portion 23, as best shown in FIG. 6. Each pin 430 extends removably into the pin space 433 of a respective one of the sleeve portions 432 via the open end 436 for urging the resilient plate segments 434 of the respective sleeve portion 432 to abut against the adjacent pair of the bars 231 of the second ventilation window portion 23. The filter member 32, 42 of each of the first and second external air filtration devices 3, 4 may be a filter screen or a static-electricity-type non-woven fabric.

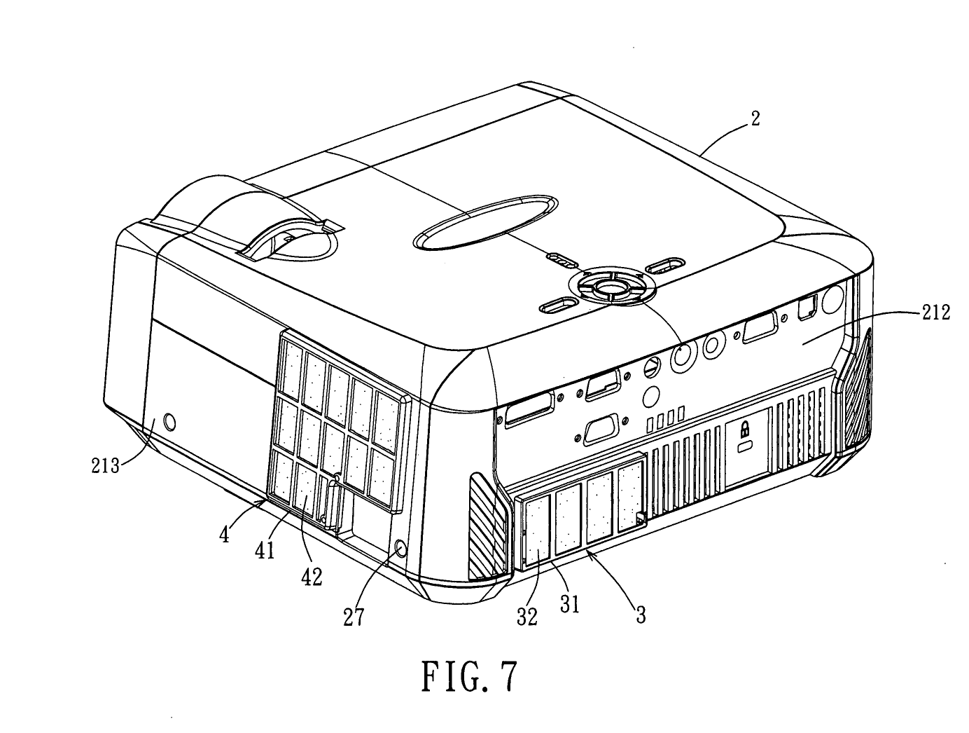

Referring to FIG. 2, FIG. 3 and FIG. 7, to mount the first external air filtration device 3 to the first ventilation window portion 22, the filter member 32 is disposed between the inner side 311 of the frame 31 and the first ventilation window portion 22. Next, the hooks 331 and the movable coupler 332 are extended into the first ventilation window portion 22 between the corresponding pair of adjacent ones of the bars 221, where the hooking end 3311 of each of the hooks 331 hooks onto a corresponding bar 221, and the engaging end 3331 of the first segment 333 of the movable coupler 332 engages a corresponding bar 221. Consequently, the filter member 32 is secured on the exterior of the rear plate portion 212 of the housing 21 between the frame 31 and the first ventilation window portion 22, thereby blocking the entry of dust into the housing 21 via the first ventilation window portion 22.

On the other hand, when it is desired to replace or clean the filter member 32, the second segment 334 of the movable coupler 332 is operated in the direction shown by arrow (A) in FIG. 3 so as to disengage the first segment 333 of the movable coupler 332 from the corresponding bar 221 of the first ventilation window portion 22. Subsequently, the frame 31 is moved slightly relative to the first ventilation window portion 22 so as to unhook the hooking ends 3311 of the hooks 331 from the corresponding bar 221. At this time, the frame 31 as well as the filter member 32 can be removed from the first ventilation window portion 22.

As shown in FIG. 2, FIG. 4 and FIG. 5, to mount the second external air filtration device 4 to the second ventilation window portion 23, the filter member 42 is disposed between the inner side 411 of the frame 41 and the second ventilation window portion 23. Next, the hooks 431 and the sleeve portions 432 are extended into the second ventilation window portion 23 between the corresponding pair of the adjacent ones of the bars 231, where the hooking end 4311 of each of the hooks 431 hooks onto a corresponding bar 231. If the filter member 42 is made from a non-woven fabric, holes corresponding in location to the hooks 431 and the sleeve portions 432 are pre-pierced for permitting extension of the hooks 431 and the sleeve portions 432 therethrough. Subsequently, with further reference to FIG. 6, each of the pins 430 is extended into the pin space 433 of a corresponding sleeve portion 432 via the open end 436 for urging the resilient plate segments 434 of the corresponding sleeve portion 432 to abut against the corresponding pair of the adjacent ones of the bars 231 of the second ventilation window portion 23. Consequently, the filter member 42 is secured on the exterior of the side plate portion 213 of the housing 21 between the frame 41 and the second ventilation window portion 23, thereby blocking the entry of dust into the housing 21 via the second ventilation window portion 23.

On the other hand, when it is desired to replace or clean the filter member 42, the pins 430 are first removed from the sleeve portions 432, and then the frame 41 is moved slightly relative to the second ventilation window portion 23 so as to unhook the hooking ends 4311 of the hooks 431 from the corresponding bars 231. At this time, the frame 41 as well as the filter member 42 can be removed from the second ventilation window portion 23.

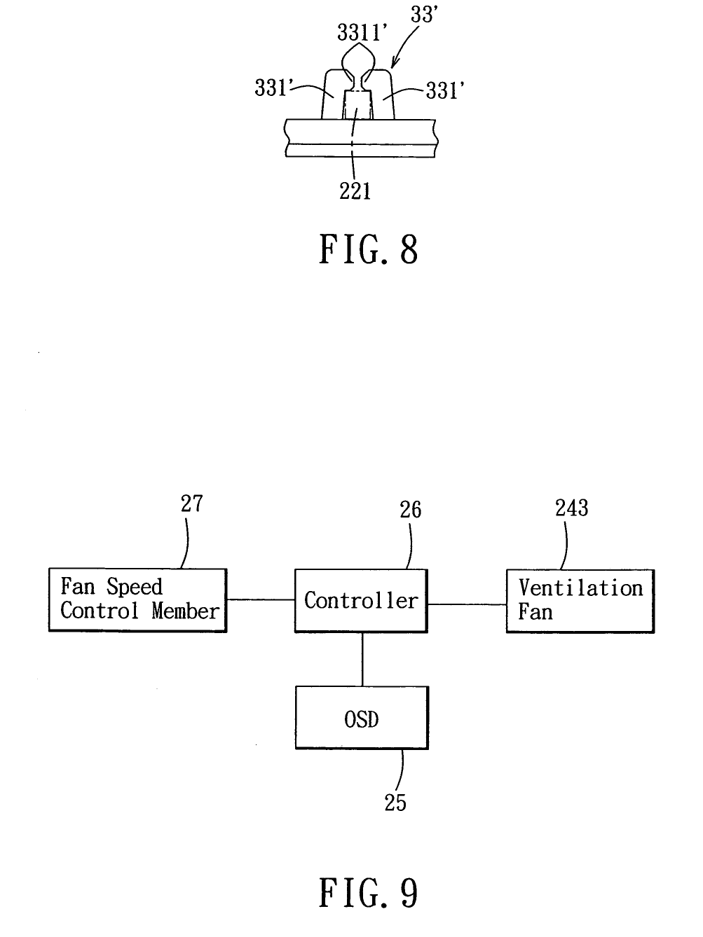

It should be noted herein that any combination of the hooks 331, 431, the movable coupler 332, and the sleeve portions 432 and the pins 430 may be used in the configuration of the engaging unit in other embodiments of the present invention. In addition, the locations, numbers, and arrangements of the hooks 331, 431, the movable coupler 332, and the sleeve portions 432 are not limited to those specifically disclosed herein. For instance, as shown in FIG. 8, according to a second preferred embodiment of the present invention, an engaging unit 33′ includes two hooks 331′, each of which has a hooking end 3311′. The hooking ends 3311′ of the hooks 331′ face each other and hook onto opposite sides of a corresponding bar 221 of the first ventilation window portion 22. Furthermore, the housing 21 may be provided with other ventilation window portions at locations other than those disclosed herein, and the external air filtration devices 3, 4 of a preferred embodiment of the present invention are mounted thereto for blocking the entry of dust.

Moreover, since the first and second ventilation window portions 22, 23 serve as airflow inlets for the ventilation fan 243, when the first and second external air filtration devices 3, 4 are respectively mounted to the first and second ventilation window portions 22, 23, the amount of airflow into the housing 21 is decreased due to the presence of the filter members 32, 42, thereby decreasing the heat-dissipation efficiency of the ventilation fan 243. As shown in FIG. 9, the projector 2 may further include a control mechanism that includes an on-screen display (OSD) 25, and a controller 26 for controlling the rotation speed of the ventilation fan 243 so as to increase the amount of airflow into the housing 21.

In this embodiment, the projector 2 further includes a fan speed control member 27 (as shown in FIG. 2 and FIG. 7) disposed on the side plate portion 213 of the housing 21 and accessible from an exterior of the housing 21. The fan speed control member 27 is operatively associated with the ventilation fan 243 for controlling the rotation speed of the ventilation fan 243. The fan speed control member 27 is preferably coupled electrically with the controller 26 so that actuation of the fan speed control member 27 results in control of the rotation speed of the ventilation fan 243 by the controller 26 without involvement of the OSD 24.

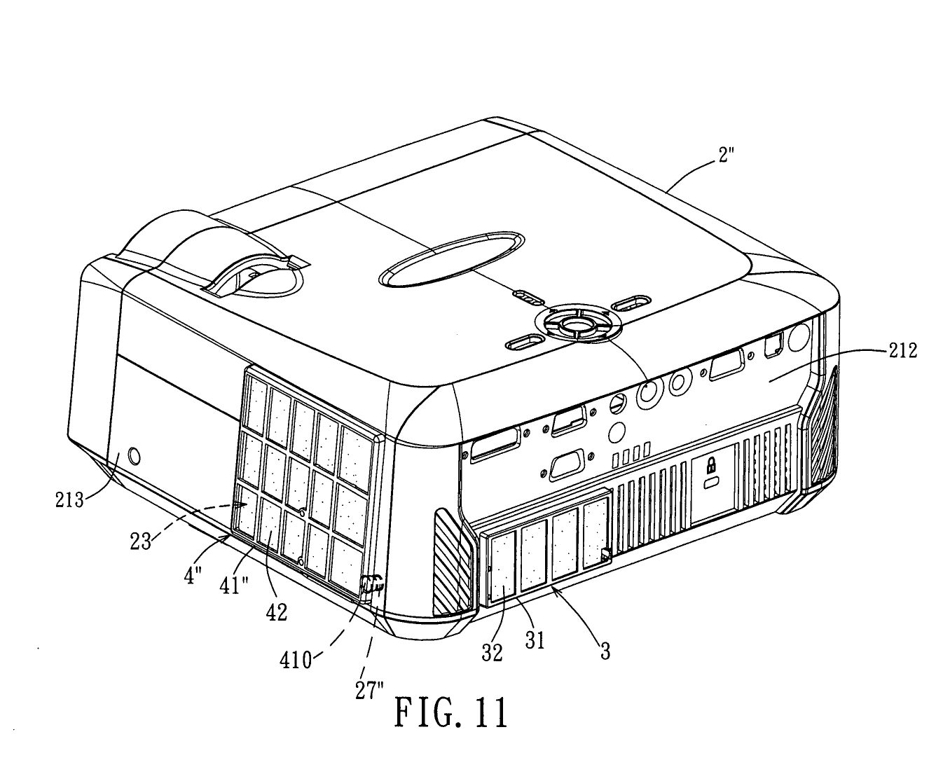

As shown in FIG. 11, according to a third preferred embodiment of the present invention, a projector 2″ further includes a fan speed control member 27″ disposed in the housing 21 and operatively associated with the ventilation fan 243 for controlling the rotation speed of the ventilation fan 241. A frame 41″ of a second external air filtration device 4″ includes an operating member 410 that extends into the housing 21 and that is registered with the fan speed control member 27″ when the frame 41″ engages the second ventilation window portion 23. The fan speed control member 27″ is actuated by the operating member 410 to control the rotation speed of the ventilation fan 243. Preferably, the operating member 410 is a fitting component that frictionally engages the housing 21 (i.e., frictionally engages the periphery of a hole in the housing 21) when the frame 41″ engages the second ventilation window portion 23.

Since projectors are normally provided with ventilation window portions, such as those (22, 23) illustrated in the foregoing, the external air filtration devices 3, 4, 4′ according to the preferred embodiments of the present invention are mounted directly to the ventilation window portions through the engaging units 33, 34 with ease. Not only are the external air filtration devices 3, 4, 4′ simple in structure, but the housing of the projectors does not require to be specially structured so as to be suitable for use with the external air filtration devices 3, 4, 4′, thereby decreasing manufacturing costs of the projectors incorporating the external air filtration devices 3, 4, 4′. Furthermore, since mounting and dismounting of the external air filtration devices 3, 4, 4′ to and form the ventilation window portions 22, 23 are easy, replacement and cleaning of the filter members 32, 42 are conveniently conducted by users. In addition, with the fan speed control member 27, 27′, the rotation speed of the ventilation fan 243 may be adjusted so as to maintain the heat-dissipating performance in the housing 21 of the projector 2, 2′.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the terms “the invention”, “the present invention” or the like do not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector comprising:
a housing having a ventilation window portion;
an internal projection mechanism disposed in said housing, and including an imaging system, a light source system for providing a light beam to said imaging system, and a ventilating fan for dissipating heat generated in said projector; and
an external air filtration device including
a frame,
a filter member, and
an engaging unit engaging removably said frame to said ventilation window portion of said housing for securing said filter member on the exterior of said housing between said frame and said ventilation window portion.

2. The projector as claimed in claim 1, wherein said engaging unit comprises at least one hook that extends from said frame toward said housing, and said hook has a hooking end for hooking onto said ventilation window portion.

3. The projector as claimed in claim 2, wherein said ventilation window portion includes a plurality of spaced apart bars, said hooking end hooking onto one of said bars.

4. The projector as claimed in claim 3, wherein said engaging unit includes two of said hooks that are spaced apart from each other, said hooking ends of said hooks facing each other and hooking onto opposite sides of said one of said bars.

5. The projector as claimed in claim 1, wherein said ventilation window portion includes a plurality of spaced apart bars,
said frame includes an inner side facing said ventilation window portion, and an outer side opposite to said inner side, and
said engaging unit includes a sleeve portion and a pin, said sleeve portion including a plurality of resilient plate segments that extend from said inner side of said frame toward said housing, that cooperate to define a pin space with an open end at said outer side of said frame, and that are removably extendable between a pair of adjacent ones of said bars of said ventilation window portion, said pin extending removably into said pin space via said open end for urging said resilient plate segments of said sleeve portion to abut against said pair of said adjacent ones of said bars.

6. The projector as claimed in claim 2, wherein said engaging unit further includes a movable coupler mounted movably on said frame, said movable coupler including a first segment that extends toward said ventilation window portion and that has an engaging end, and a second segment that extends from said first segment away from said ventilation window portion and that is operable to engage removably said engaging end of said first segment to said ventilation window portion.

7. The projector as claimed in claim 1, further comprising a fan speed control member disposed on said housing and accessible from the exterior of said housing, said fan speed control member being operatively associated with said ventilation fan for controlling rotation speed of said ventilation fan.

8. The projector as claimed in claim 1, further comprising a fan speed control member disposed in said housing and operatively associated with said ventilation fan for controlling rotation speed of said ventilation fan, said frame of said external air filtration device including an operating member that extends into said housing and that is registered with said fan speed control member when said frame engages said ventilation window portion, said fan speed control member being actuated by said operating member to control the rotation speed of said ventilation fan.

9. The projector as claimed in claim 8, wherein said operating member is a fitting component that frictionally engages said housing when said frame engages said ventilation window portion.

10. The projector as claimed in claim 1, wherein said ventilation window portion serves as an airflow inlet for said ventilation fan.
